(19) United States
(12) Patent Application Publication
(10) Pub. No.: US 2020/0133935 A1
(43) Pub. Date: Apr. 30, 2020

(54) METHOD, APPARATUS AND COMPUTER PROGRAM PRODUCT FOR COMPARING FILES

(71) Applicant: EMC IP Holding Company LLC, Hopkinton, MA (US)

(72) Inventors: Qin Liu, Chengdu (CN); Yi Wang, Chengdu (CN)

(21) Appl. No.: 16/284,567

(22) Filed: Feb. 25, 2019

(30) Foreign Application Priority Data
Oct. 26, 2018 (CN) 201811260855.2

(51) Int. Cl. G06F 16/23; G06F 16/22

(52) U.S. Cl. CPC G06F 16/2365; G06F 16/2255

(57) ABSTRACT

The present disclosure provides a method, a device, and a computer program product for file comparison. In one embodiment, the method includes determining a set of data blocks of the first file associated with the first segment and a set of data blocks of the second file associated with the second segment, obtaining a first mapping information for data blocks in the set of data blocks of the first file and a second mapping information for data blocks in the set of data blocks of the second file, and determining a difference between the first segment and the second segment based on the first mapping information and the second mapping information.

### FIELD

Embodiments of the present disclosure relate to the field of data analysis and, more specifically to a method, a device, and a computer program product for comparing files.

### BACKGROUND

Users often need to store files of a client in a backup storage system to prevent data loss and to save local storage space. Sometimes, files of a client change over time, thereby requiring the generation of multiple backups, each generated at a different time, which are stored in the backup storage system. In this scenario, a user might need to compare the multiple backups to determine the difference between the multiple backups. For example, a restaurant manager will record a number of steaks sold each day and count a number of steaks sold each month to predict a number of steak to be prepared next month. During this process, files that record information of the number of sold steaks change constantly over time, resulting in backup files at different time points. These backup files are all stored in the backup storage system, and the restaurant manager predicts the number of steaks to be prepared next month by comparing backup files at different time points.

However, traditional approaches to comparing multiple backups require that the backup files themselves be transferred to the client first, and then compared at the client. This manner typically requires a large data transmission bandwidth and wastes network resources. Further, because the respective backups include mostly the same data, it is inefficient to compare all content of the backups.

### SUMMARY

Embodiments of the present disclosure provide a method, a device, and a computer program product for comparing files.

In a first aspect of the present disclosure, there is a method of file comparison. The method comprises: in response to receiving a request to compare a first segment of a first file with a second segment of a second file, determining a set of data blocks of the first file associated with the first segment and a set of data blocks of the second file associated with the second segment; obtaining a first mapping information for data blocks in the set of data blocks of the first file and a second mapping information for data blocks in the set of data blocks of the second file; and determining a difference between the first segment and the second segment based on the first mapping information and the second mapping information, wherein the first mapping information and the second mapping information are generated based on the set of data blocks of the first file and the set of data blocks of the second file, respectively.

In a second aspect of the present disclosure, there is provided a device for file comparison. The device comprises: a processor, and a memory coupled to the processor and having instructions stored therein, the instructions, when executed by the processor, causing the device to perform acts, the acts comprising: in response to receiving a request to compare a first segment of a first file with a second segment of a second file, determining a set of data blocks of the first file associated with the first segment and a set of data blocks of the second file associated with the second segment; obtaining a first mapping information for data blocks in the set of data blocks of the first file and a second mapping information for data blocks in the set of data blocks of the second file; and determining a difference between the first segment and the second segment based on the first mapping information and the second mapping information, wherein the first mapping information and the second mapping information are generated based on the set of data blocks of the first file and the set of data blocks of the second file, respectively.

In a third aspect of the present disclosure, there is provided a computer program product that is tangibly stored on a computer-readable medium and comprises machine-executable instructions. The machine-executable instructions, when executed, cause a machine to perform the method according to the first aspect.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The above and other objectives, features, and advantages of example embodiments of the present disclosure will become more apparent from the following detailed description with reference to the accompanying drawings, in which the same reference symbols refer to the same elements:

FIG. 1 illustrates a schematic diagram of an environment in which embodiments of the present disclosure may be implemented;

FIG. 2 illustrates a flow chart of a method of file comparison in accordance with an embodiment of the present disclosure;

FIG. 3 illustrates a schematic diagram of generating mapping information during a backup operation according to an embodiment of the present disclosure;

FIGS. 4A-4C respectively illustrate schematic diagrams for determining file differences by comparing mapping information according to an embodiment of the present disclosure; and

FIG. 5 illustrates a block diagram of an exemplary device that may be used to implement embodiments of the present disclosure.

### DETAILED DESCRIPTION OF EMBODIMENTS

The principles of the present disclosure are described below with reference to several exemplary embodiments illustrated in the drawings. Although preferred embodiments of the present disclosure have been shown in the drawings, it should be appreciated that these embodiments are described only to enable those skilled in the art to better understand and thereby implement the present disclosure, not to limit the scope of the present disclosure in any manner.

As used herein, the term “includes” and its variants are to be read as open-ended terms that mean “includes, but is not limited to.” The term “or” is to be read as “and/or” unless the context clearly indicates otherwise. The term “based on” is to be read as “based at least in part on.” The term “one exemplary implementation” and “an exemplary implementation” are to be read as “at least one exemplary implementation.” The term “another implementation” is to be read as “at least one other implementation.” Terms “a first”, “a second” and others may denote different or identical objects. The following text may also contain other explicit or implicit definitions.

The term “data” as used herein includes data in a storage system, which may be in various formats and contain various content, such as electronic documents, image data, video data, audio data, or data in any other formats; moreover, the term “backup” and “storage” are used interchangeably herein.

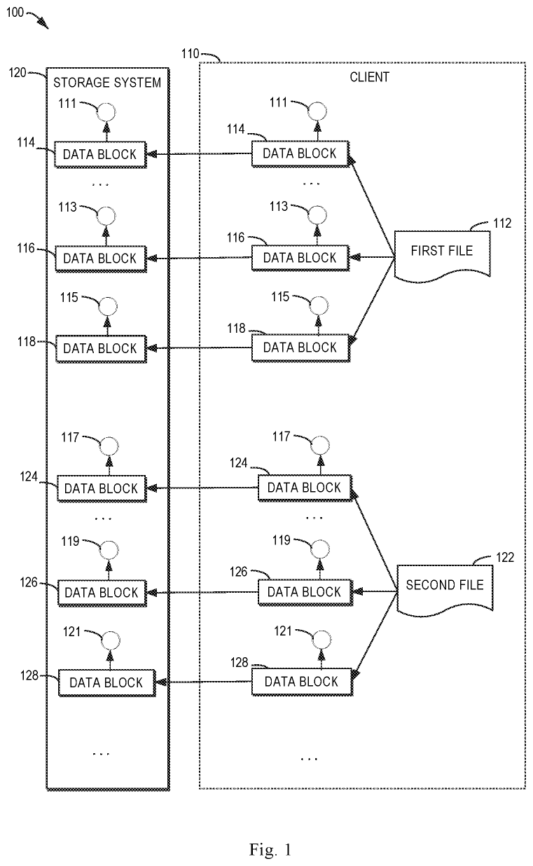

FIG. 1 shows a schematic diagram of an environment 100 in which embodiments of the present disclosure may be implemented. As shown in FIG. 1, environment 100 includes a client 110 and a storage system 120 for backing up files or data from the client 110. Those skilled in the art should appreciate that while only one client 110 is shown by way of examples in the environment 100, the storage system 120 may back up data for a plurality of such clients 110. Although only one storage system 120 is exemplarily shown in the environment 100, there may be multiple such storage systems 120.

In addition, although FIG. 1 only exemplarily shows a first file 112 and a second file 122 to be backed up to the storage system 120, there may be a plurality of such files to be backed up at the client. The file backup process in the environment 100 of FIG. 1 is described below by taking the backup of the first file 112 as an example. However, those skilled in the art will appreciate that a similar backup process may also be performed for the second file 122.

In order to back up the first file 112 of the client 110 to the storage server 120, the first file 112 may be divided into a plurality of data blocks 114, 116, 118, etc. and then the plurality of data blocks are backed up to the storage system 120. Thus, the first file 112 will be associated with a plurality of data blocks 114, 116, 118, etc. The division of the file into data blocks may be performed in various manners in the prior art, and the manner may be selected as needed. For example, in some embodiments, the division into data blocks for files having similar content (e.g., backup files formed by the same file at different points in time) may cause the same data content to be divided into the same data block(s), while in other embodiments, the division into data blocks may be performed according to the starting position and the size of the data block.

Furthermore, the term “data block” mentioned herein may refer to both raw data obtained directly by dividing a file, and data formed by encrypting and compressing the raw data obtained from the division to increase security. Embodiments of the present disclosure are not limited in this aspect.

An advantage of dividing the first file 112 into multiple data blocks for backup is that the fragmented storage resource may be utilized to optimize the use of the storage space of the backup system. Further, the same data block may be stored only once, and shared by all files with this data block, thereby saving storage space.

It should be noted that after the first file 112 or the second file 122 is backed up from the client to the storage system 120, the first file 112 and the second file 122 located at the client may be deleted to save the storage space of the client. However, the first file 112 and the second file 122 may also be retained at the client for other considerations.

In the case where the client does not retain the first file 112 and the second file 122, in the prior art if the backed-up first file 112 needs to be retrieved from the storage system 120 for analysis, it needs to be retrieved entirely. Even if the file is stored in the form of data blocks, it may be necessary to retrieve all the data blocks 114, 116, 118, etc. which are associated with the first file 112, restore the first file 112 and then perform analysis.

If a comparison among a plurality of files (for example, the first file 112 and the second file 122) is involved, the above operation needs to be performed for each backup file. This traditional approach consumes a large data transmission bandwidth and wastes network resources. Further, because respective backups include substantially similar content, it is inefficient to compare all contents of the files.

In order to at least partially address one or more of the above problems as well as other potential problems, embodiments of the present disclosure propose a solution for comparing files. In this solution, a corresponding mapping element is generated for each data block, and a comparison between the mapping elements is used to determine the difference between the data blocks, thereby improving the file comparison efficiency. In addition, due to the efficiency and convenience of the solution, it is possible to perform the comparison operation at the storage system 120 side to obtain the different data, and only return the different data to the client 110, thereby further substantially saving network resources.

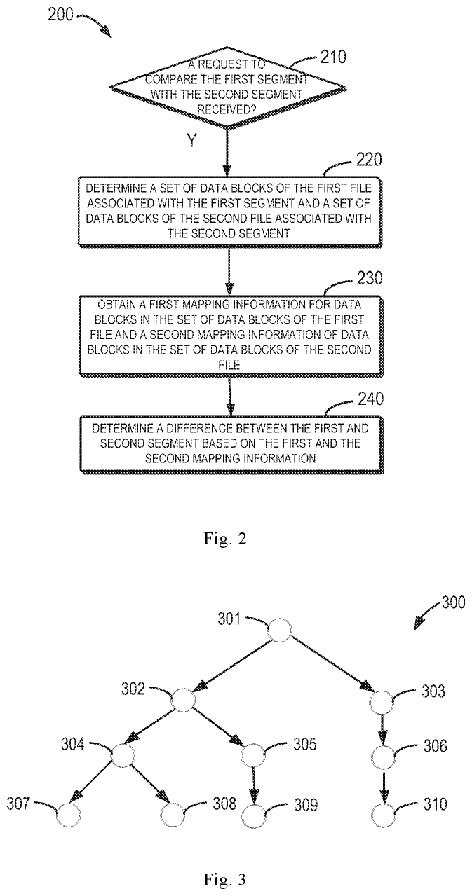

Embodiments of the present disclosure will be described in detail below with reference to the accompanying drawings. FIG. 2 shows a flow diagram of a method 200 of file comparison in accordance with an embodiment of the present disclosure. The method 200 may be implemented by a corresponding device that may be implemented on the storage system 120 in whole or in a distributed manner. Method 200 is discussed still with reference to the architecture of FIG. 1 for ease of discussion.

Upon receiving a request to compare a first segment of a first file with a second segment of a second file at 210, determine, at 220, a set of data blocks of the first file associated with the first segment and a set of data blocks of the second file associated with the second segment.

Those skilled in the art may appreciate that the terms “first file” and “second file” as referred to herein are used to distinguish between the two files only, rather than to limit a specific content of the file.

In some embodiments, for example, the first file 112 and the second file 122 shown in FIG. 1 may be different backup files at different time points for the same source file. For example, in the example of the restaurant given in the Background, the first file 112 may be a file that records information of the number of the steaks sold until last month in the business year, and the second file 122 may be a file that records information of the number of steaks until the current day in the business year.

In other embodiments, the first file 112 and the second file 122 may be files with strong association in content. For example, the first file 112 may be a file that records information of the number of the steak sold only in last month, and the second file 122 may be a file that records information of the number of steaks sold only in the current month. In other embodiments, the first file 112 and the second file 122 may also be any two files that a user wants to compare.

In an embodiment of the present disclosure, the request to compare the first file 112 and the second file 122 may be a request to compare some or all of the two files. That is, the request may be a request to compare the full text of the first file 112 and the second file 122, or may be a request to compare only a segment of each of the two files, thereby increasing the flexibility of comparison. When the file is large and the user clearly knows a specific segment of content needed to be compared, increasing the flexibility of the comparison may greatly improve the comparison efficiency. It should be understood that the terms “first segment” and “second segment” used herein respectively refer to at least a segment of the first file and the second file, and are not intended to limit the specific content of the file.

In some embodiments, an indication of the first segment/second segment may be provided in a request to compare the first segment and the second segment to identify objects that need to be compared. Taking the indication of the first segment as an example, the method 200 may further include the step of determining at least one of the following information associated with the first segment based on the received request: a file name, a file path, a comparison start position and a comparison end position, a comparison start position and a comparison length, and a comparison end position and a comparison length.

The comparison start position and comparison end position may be indicated by a specific file line number, or may be indicated by a specific keyword. For example, a line number 10 is given in the request to indicate that the comparison starts from the 10^{th} line of the first file 112 or the comparison ends to the 10^{th} line of the first file 112; the keyword “steak sales volume” is given in the request to indicate that comparison starts from the content of the first file 112 where “steak sales volume” appears for the first time or comparison ends when “steak sales volume” appear in the first file 112 for the first time. The embodiment of the present disclosure is not limited in this aspect. It should be appreciated by those skilled in the art that the manner of indicating the second segment of the second file 122 is similar to the manner of indicating the first segment of the first file 112, and is not described in detail.

As previously mentioned, the first file 112 and the second file 122 are each associated with a plurality of data blocks in the storage system 120. For example, the first file 112 is associated with data blocks 114, 116, and 118, etc. in the storage system 120; the second file 122 is associated with data blocks 124, 126, and 128, etc. in the storage system 120. As such, when the objects of comparison are the first segment of the first file 112 and the second segment of the second file 122, it is necessary to obtain a first set of data blocks associated with the first segment and a second set of data blocks associated with the second segment. Similarly, the “first set of data blocks” and the “second set of data blocks” mentioned herein are used only to distinguish between the two, rather than limiting the specific content of the set of data blocks.

Further referring to FIG. 2, in step 230, a first mapping information for the data block in the set of data blocks of the first file and a second mapping information for the data block in the set of data blocks of the second file are obtained, and the first mapping information and the second mapping information are generated based on the set of data blocks of the first file and the set of data blocks of the second file, respectively. Those skilled in the art may understand that the mapping information may at least include a set of mapping elements of respective data blocks in the set of data blocks, and the mapping elements of respective data blocks may be associated with the content of the corresponding data blocks (described below).

It may be appreciated by those skilled in the art that the mapping information, associated with the data block set per se, may at least partially indicate the data blocks in the set of data blocks in addition to being used to index the corresponding set of data blocks.

According to an embodiment of the present disclosure, the mapping information for the data block set may be generated in the following manner. As shown in FIG. 1, it is possible to, with the unit of data block, determine corresponding mapping elements 111, 113, 115, etc. or each of the data blocks 114, 116, 118, etc. divided for the first file 112, respectively, determine corresponding mapping elements 117, 119, 121, etc. for each of the data blocks 124, 126, 128, etc. divided for the second file 122 respectively, and generate mapping information for the set of data blocks based on the determined respective mapping elements. The mapping information generated in this way embodies the information of each data block through the mapping element on which it is based, thereby facilitating the formation of an index path for each data block and providing an indication of the data block. Description is presented by taking the generation of the mapping information for the data blocks 114, 116, 118, etc. of the first file 112 as an example. However, those skilled in the art should understand that the same process is also applicable to generation of the mapping information for the data blocks 124, 126, 128, etc. or the second file 122.

In a further embodiment of the present disclosure, the mapping information may be generated based on both the mapping elements 111, 113, 115, etc. of each data block 114, 116, 118, etc. and index paths generated by these mapping elements. This embodiment will be specifically described later with reference to FIG. 3.

In a further example, the mapping elements 111, 113, 115, etc. may be obtained by generating hash values for the respective data blocks and then performing the determination based on the hash values. Due to the one-one correspondence between the hash values and the mapping elements, the mapping elements 111, 113, 115 obtained in this way may be used to uniquely identify the corresponding data blocks and index to the corresponding data blocks. In other examples, the mapping elements 111, 113, 115, etc. may be obtained in other mapping manners in the field so long as they have a corresponding relationship with respective data blocks.

As shown in FIG. 1, respective data blocks 114, 116, 118, etc. along with their respective mapping elements 111, 113, 115, etc. may be backed up together into the storage system 120 for subsequent use upon indexing and comparing the data blocks. It should to be appreciated that FIG. 1 only shows one example environment, whose structure and number of files are merely exemplary, and are not intended to impose any limitation on the embodiments of the present disclosure. The environment may include more files, data blocks, and associated backup operations. For example, the environment 100 may include, in addition to the file 112, other files to be backed up, their respective data blocks, and corresponding mapping elements.

In some embodiments, mapping information may be generated based on respective mapping element 111, 113, 115, etc. in the above-described backup process. For example, FIG. 3 illustrates a schematic diagram 300 of generating mapping information in a backup operation according to an embodiment of the present disclosure. To simplify the description, it is assumed that this operation is to back up file 1, file 2, and file 3, wherein file 1 is divided into two data blocks (not shown) whose respective mapping elements are 307 and 308; file 2 is divided as one data block (not shown) whose mapping element is 309; file 3 is divided as one data block (not shown) whose mapping element is 310. Respective data blocks, together with mapping information 307-310, are backed up into the storage system 120.

As described above, the mapping elements 307-310 may be determined based on the hash values generated by the respective data blocks, respectively. The hash values corresponding to data blocks with the same content are the same, thereby forming the same mapping element, and the hash values corresponding to data blocks with different content are different, thereby forming different mapping elements. Hence, the mapping elements 307-310 may be used to identify corresponding data blocks.

In addition, in order to facilitate subsequent indexing of data blocks of the file backed up this time, an index path may be formed based on respective mapping elements 307-310. For example, it is possible to generate the mapping information 304 of the file 1 based on the file name of the file 1 and the mapping elements 307 and 308 of the data blocks associated with the file 1; generate the mapping information 305 of the file 2 based on the file name of the file 2 and the mapping element 309 of the data block associated with the file 2; generate the mapping information 306 of file 3 based on the file name of the file 3 and the mapping element 310 of the data block associated with the file 3.

Similarly, in an embodiment of the present disclosure, it is also possible to generate the mapping information for a file directory based on the file directory and files under the directory. Assume that the file 1 and file 2 are under the same file directory and the file 3 is under another directory, the mapping information 302 of the file directory is generated for example based on the file directory where the file 1 and the file 2 are located and the mapping elements 304 and 305 of the file 1 and the file 2 under the directory; and the mapping information 303 of the file directory is generated based on the file directory where the file 3 is located and the mapping information 306 of file 3 under the other directory.

Similarly, in some examples, it is possible to generate the mapping information 301 of backup of this time as an entry for the backup file lookup based on file directories 302 and 303 involved in the backup operation of this time, and one or more items in metadata such as the time of the backup operation, backup acquisition authorization and the creator information. Those skilled in the art should understand that, for example, mapping information 301, 302, and 304 forms an index path for indexing file 1; for example, mapping information 301, 302, and 305 forms an index path for indexing file 2; for example, mapping information 301, 303, and 306 forms an index path for indexing file 3. As described above, these index paths may be generated based on the mapping elements 307-310 corresponding to the respective data blocks, and together with the associated mapping elements, serve as mapping information for respective files.

It should be appreciated by those skilled in the art that although the mapping element is formed through mapping elements of data blocks and the index path formed by respective mapping information generated based on the mapping element in the specific example shown in FIG. 3, the mapping information may be generated in other manners, for example, the mapping information is formed only by the mapping elements of respective data blocks, as long as the mapping information is generated based on relevant set of data blocks.

In some embodiments, the generated mapping information, for example as shown in FIG. 3, may be stored in the storage system 120 for subsequent use in indexing and comparing data blocks.

Returning to method 200, at 240, a difference between the first segment and the second segment is determined based on the first mapping information and the second mapping information. It should be understood that this difference may indicate the distinction or difference between the first segment and the second segment.

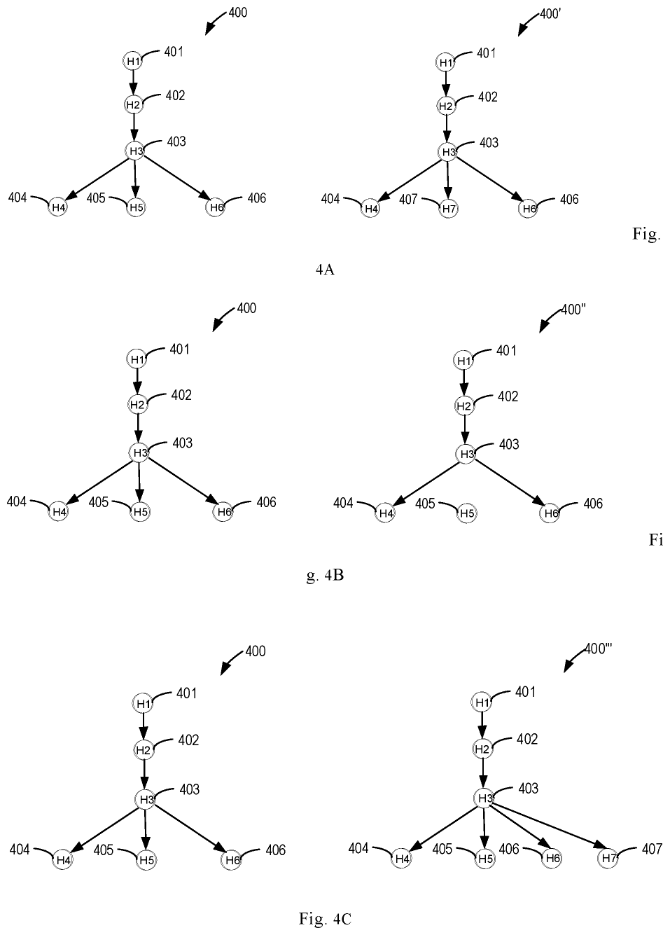

According to an embodiment of the present disclosure, the difference between the first segment and the second segment may be determined in various ways. FIG. 4A-4C illustrate exemplary diagrams for determining file variability by comparing mapping information, in accordance with an embodiment of the present disclosure. Specifically, FIG. 4A shows exemplary first mapping information 400 and second mapping information 400′. In this example, assume that there are three data blocks (not shown) associated with the first segment of the first file 112, with their respective mapping elements being 404-406.

Similar to the structure of the mapping information described with reference to FIG. 3, the first mapping information 400 may include mapping elements 404-406, and mapping information 403, 402, and 401 generated based on the mapping elements 404-406, respectively for use in indexing the file, the file directory, and the backup of this time.

For ease of illustration, it is assumed that the second file 122 and the first file 112 are backup files for different times of the same source file. The second file 122 is also divided into three data blocks, wherein only one data block is different from the data block of the first file 112, with a corresponding mapping element being 407.

According to an embodiment of the present disclosure, the determination of the difference between the first segment and the second segment may be performed based on the first mapping information 400 and the second mapping information 400′. For example, when it is determined that there is a difference between the first mapping information 400 and the second mapping information 400′, it may be considered that there is a difference between the first segment and the second segment.

In some embodiments, the specific difference between the first segment and second segment may be determined by comparing a first set of mapping elements corresponding to all data blocks in the set of data blocks of the first file and a second set of mapping elements corresponding to all data blocks in the set of data blocks of the second file. For example, in response to the first set of mapping elements 404, 405, and 406 being not all identical to the second set of mapping elements 404, 407, 406, determine that the first segment is different than the second segment.

Furthermore, it is possible to determine specific different parts between the first segment and the second segment by comparing the mapping elements of the specific data blocks. For example, it is possible to compare 404 in the first set of mapping elements with a corresponding sequential element 404 of the second set of mapping elements, compare 405 in the first set of mapping elements with a corresponding sequential element 407 in the second set of mapping elements, and compare 406 in the first set of mapping elements with corresponding sequential elements 406 in the second set of mapping elements, thereby determining that the difference is a data block associated with the mapping element 405 of the first segment and a data block associated with the mapping element 407 of the second segment.

In a further embodiment according to the present disclosure, it is possible to restore at least one portion of the first segment and at least one portion of the second segment respectively based on respective data blocks associated with the difference, and send the restored at least one portion of first segment and the restored at least one portion of the second segment to the client.

As an alternative manner, FIG. 4B illustrates additional exemplary first mapping information 400 and second mapping information 400″. In this example, it is possible to, by comparing the first mapping information 400 and the second mapping information 400″, find that the mapping element 405 is missing in the second mapping information 400″, thereby determining the difference between the first segment and the second segment lies in a data block corresponding to the mapping element 405; it is also possible to, by sequentially comparing 404 in the first set of mapping elements with 404 in the second set of mapping elements, 405 in the first set of mapping elements with 406 in the second set of mapping elements, determine that the difference between the first segment and the second segment lies in the data blocks corresponding to the mapping elements 405 and 406. The specific comparison policy may be set as needed, and the embodiments of the present disclosure are not limited herein.

As a further alternative example, FIG. 4C illustrates further exemplary first mapping information 400 and second mapping information 400′″. In this example, it is possible to, by comparing the first mapping information 400 and the second mapping information 400′″, find that the mapping element 407 is added in the second mapping information 400′″, thereby determining that the difference between the first segment and the second segment lies in the data block corresponding to the mapping element 407.

In addition, in response to the first set of mapping elements being all identical to the second set of mapping elements (not shown in FIGS. 4A-C), it is determined that the first segment is identical to the second segment.

A solution for comparing files according to an embodiment of the present disclosure is described above with reference to FIG. 1 through FIGS. 4A-4C. The solution determines the difference between the files by comparing the mapping information associated with sets of data blocks of the files to be compared, may improve the efficiency of the comparison on the one hand, and may merely return the different segment on the other hand, thereby saving network resources.

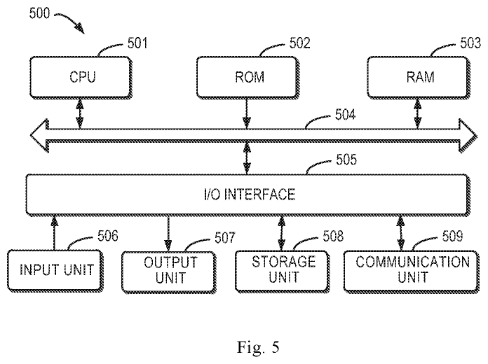

FIG. 5 illustrates a block diagram of an electronic device 500 adapted to implement the embodiments of the present disclosure. The device may be used to implement the method 200 of file comparison as shown in FIG. 2. As shown in FIG. 5, the device 500 comprises a central processing unit (CPU) 501 that may perform various appropriate actions and processing based on computer program instructions stored in a read-only memory (ROM) 502 or computer program instructions loaded from a memory unit 508 to a random access memory (RAM) 503. In the RAM 503, there further store various programs and data needed for operations of the device 500. The CPU 501, ROM 502 and RAM 503 are connected to each other via a bus 504. An input/output (I/O) interface 505 is also connected to the bus 504.

A plurality of components in the device 500 are connected to the I/O interface 505, comprising: an input unit 506 such as a keyboard, a mouse and the like; an output unit 507 such as various kinds of displayers and loudspeakers, etc.; a storage unit 508 such as a magnetic disk, an optical disk, and etc.; a communication unit 509 including a network card, a modem, and a wireless communication transceiver, etc. The communication unit 509 allows the device 500 to exchange information/data with other devices through a computer network such as the Internet and/or various kinds of telecommunications networks.

Various processes and processing described above, e.g., method 200 for file comparison, may be executed by the processing unit 501. For example, in some embodiments, the method 200 may be implemented as a computer software program that is stored on a machine readable medium, e.g., the storage unit 508. In some embodiments, part or all of the computer program may be loaded and/or mounted onto the device 500 via ROM 502 and/or communication unit 509. When the computer program is loaded to the RAM 503 and executed by the CPU 501, one or more operations of the above described method 200 are implemented. Alternatively, in other embodiments, CPU 501 may be configured to implement one or more operations of the method 200 and/or method 400 in any other proper manner (for example, by means of firmware).

It should be further indicated that the present disclosure may be a method, an device, a system and/or a computer program product. The computer program product may include a computer readable storage medium having computer readable program instructions thereon for carrying out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local region network, a wide region network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on a user's computer, partly on a user's computer, as a stand-alone software package, partly on a user's computer and partly on a remote computer or entirely on the remote computer or server. In the latter scenario, the remote computer may be connected to the user's computer through any type of network, including a local region network (LAN) or a wide region network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, device (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams illustrate the architecture, functionality, and operation of possible implementations of systems, methods and computer program products according to various embodiments of the present disclosure. In this regard, each block in the flowchart or block diagrams may represent a module, snippet, or portion of code, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What have been mentioned above are only some optional embodiments of the present disclosure and are not limiting the present disclosure. For those skilled in the art, the present disclosure may have various alternations and changes. Any modifications, equivalents and improvements made within the spirits and principles of the present disclosure should be included within the scope of the present disclosure.

1. A method of file comparison, comprising:
in response to receiving a request to compare a first segment of a first file with a second segment of a second file, determining a first set of data blocks of the first file associated with the first segment and a set second of data blocks of the second file associated with the second segment;
obtaining a first mapping information for the first set of data blocks and a second mapping information for the second set of data blocks, the first mapping information and the second mapping information being generated based on the first set of data blocks and the second set of data blocks, respectively; and
determining a difference between the first segment and the second segment using the first mapping information and the second mapping information.

2. The method according to claim 1, further comprising:
determining mapping elements corresponding to the first set of data blocks; and
generating the first mapping information based on the determined mapping elements.

3. The method according to claim 2, wherein determining the mapping elements comprises:
generating hash values for the first set of data blocks of the first file; and
determining the mapping elements corresponding to the first set of data blocks based on the hash values.

4. The method according to claim 1, wherein determining the difference between the first segment and the second segment further comprises:
comparing a first set of mapping elements corresponding to the first set of data blocks and a second set of mapping elements corresponding to the second set of data blocks;
in response to the first set of mapping elements being not all identical to the second set of mapping elements, determining that the first segment is different from the second segment.

5. The method according to claim 1, further comprising:
restoring at least one portion of the first segment and at least one portion of the second segment associated with the difference; and
sending the restored at least one portion of the first segment and the restored at least one portion of the second segment.

6. The method according to claim 1, further comprising:
determining, based on the request, information associated with the first segment of the first file, wherein the information comprises at least one selected from a group consisting of:
a file name,
a file path,
a comparison start position and a comparison end position,
a comparison start position and a length, and
a comparison end position and a length.

7. The method according to claim 1, wherein the first file and the second file are different backup files for a same source file.

8. A device for file comparison, comprising:
a processor; and
a memory coupled to the processor and having instructions stored therein, the instructions, when executed by the processor, causing the device to a method, the method comprising:
in response to receiving a request to compare a first segment of a first file with a second segment of a second file, determining a first set of data blocks of the first file associated with the first segment and a set second of data blocks of the second file associated with the second segment;
obtaining a first mapping information for the first set of data blocks and a second mapping information for data blocks in the second set of data blocks, the first mapping information and the second mapping information being generated based on the first set of data blocks and the second set of data blocks, respectively; and
determining a difference between the first segment and the second segment using the first mapping information and the second mapping information.

9. The device according to claim 8, wherein the method further comprises:
determining mapping elements corresponding to the first set of data blocks; and
generating the first mapping information based on the determined mapping elements.

10. The device according to claim 9, wherein determining the mapping elements comprises:
generating hash values for the first set of data blocks of the first file; and
determining the mapping elements corresponding to the first set of data blocks based on the hash values.

11. The device according to claim 8, wherein determining the difference between the first segment and the second segment further comprises:
comparing a first set of mapping elements corresponding to the first set of data blocks and a second set of mapping elements corresponding to the second set of data blocks;
in response to the first set of mapping elements being not all identical to the second set of mapping elements, determining that the first segment is different from the second segment
in response to the first set of mapping elements being all identical to the second set of mapping elements, determining that the first segment is identical to the second segment.

12. The device according to claim 8, the acts further comprising:
restoring at least one portion of the first segment and at least one portion of the second segment associated with the difference; and
sending the restored at least one portion of the first segment and the restored at least one portion of the second segment.

13. The device according to claim 8, wherein the method further comprises:
determining, based on the request, information associated with the first segment of the first file, wherein the information comprises at least one selected from a group consisting of:
a file name,
a file path,
a comparison start position and a comparison end position,
a comparison start position and a length, and
a comparison end position and a length.

14. The device according to claim 8, wherein the first file and the second file are different backup files for a same source file.

15. A computer program product being tangibly stored on a computer-readable medium and comprising machine-executable instructions, the machine-executable instructions, when executed, causing a machine to perform a method, the method comprising:
in response to receiving a request to compare a first segment of a first file with a second segment of a second file, determining a first set of data blocks of the first file associated with the first segment and a set second of data blocks of the second file associated with the second segment;
obtaining a first mapping information for the first set of data blocks and a second mapping information for the second set of data blocks, the first mapping information and the second mapping information being generated based on the first set of data blocks and the second set of data blocks, respectively; and
determining a difference between the first segment and the second segment using the first mapping information and the second mapping information.

16. The computer program product according to claim 15, wherein the method further comprises:
determining mapping elements corresponding to the first set of data blocks; and
generating the first mapping information based on the determined mapping elements.

17. The computer program product according to claim 16, wherein determining the mapping elements comprises:
generating hash values for the first set of data blocks of the first file; and
determining the mapping elements corresponding to the first set of data blocks based on the hash values.

18. The computer program product according to claim 15, wherein determining the difference between the first segment and the second segment further comprises:
comparing a first set of mapping elements corresponding to the first set of data blocks and a second set of mapping elements corresponding to the second set of data blocks;
in response to the first set of mapping elements being not all identical to the second set of mapping elements, determining that the first segment is different from the second segment.

19. The computer program product according to claim 15, wherein the method further comprises:
restoring at least one portion of the first segment and at least one portion of the second segment associated with the difference; and
sending the restored at least one portion of the first segment and the restored at least one portion of the second segment.

20. The computer program product according to claim 15, wherein the method further comprises:
determining, based on the request, information associated with the first segment of the first file, wherein the information comprises at least one selected from a group consisting of:
a file name,
a file path,
a comparison start position and a comparison end position,
a comparison start position and a length, and
a comparison end position and a length.
